(19) United States
(12) Patent Application Publication
(10) Pub. No.: US 2018/0177209 A1
(43) Pub. Date: Jun. 28, 2018

(54) Production line and method for making Frono cold dessert

(71) Applicant: MohammadReza Shekarforoosh, Delray Beach, FL (US)

(72) Inventor: MohammadReza Shekarforoosh, Delray Beach, FL (US)

(73) Assignee: MohammadReza Shekarforoosh, Delray Bach, FL (US)

(21) Appl. No.: 15/387,864

(22) Filed: Dec. 22, 2016

(51) Int. Cl. A23G 9/08; A23G 9/32

(52) U.S. Cl. CPC A23G 9/08; A23V 2002/00; A23G 9/32

(57) ABSTRACT

Everyone loves ice cream [symbol] , but not everyone can eat ice cream due to several reasons such as, Lactose Intolerance (up to today, about 30 million Americans are lactose-intolerant), sugar problem, fat problem and etc. Frono, not only does not have ice cream problems, but, is also gluten free, dairy-free, vegan-free, and can be non-GMO. Like ice cream, you can have Frono in as many as flavors and tastes that you like. Moreover, for those that love to eat ice cream, they can mix Frono and ice cream together and enjoy a new unique dessert [symbol] .

### TECHNICAL FIELD

The present innovation relates to method for manufacturing and producing pasteurized and homogenized (or regular) durable Frono and production line of it.

### BACKGROUND ART

Everyone loves ice cream [symbol] , but not everyone can eat ice cream due to several reasons such as, Lactose Intolerance (up to today, about 30 million Americans are lactose-intolerant), sugar problem, fat problem and . . . Frono (Falodeh), not only does not have ice cream problems, but, is also gluten free, dairy-free, vegan-free, and can be non-GMO. Like ice cream, you can have Frono in as many as flavors and tastes that you like. Moreover, for those that love to eat ice cream, they can mix Frono and ice cream together and enjoy a new unique dessert [symbol] .

### SUMMARY OF INVENTION

The present innovation relates to method for manufacturing and producing pasteurized and homogenized (or regular) Frono and production line of it.

First we should mix water and sugar (or any kind natural or artificial sweetener) until there is no evidence of sweetener and water becomes a thick, sweet liquid. Depending on what type of sweetener we would pick, we may need direct or indirect heat to make this happen.

If we want to make pasteurized or homogenized product we will transfer the sweetened liquid to pasteurizer and homogenizer by using a pump. (Or by bucket)

After that, we will transfer the sweetened liquid to a freezer type device like an ice cream maker to bring the sweetened liquid temperature very low. But, we don't want it to become completely frozen. After the temperature is low enough, the color of sweetened liquid will become white and will not be liquid anymore. It will have a creamy consistency.

In this step, we will mix some water (we can use pasteurized or homogenized water too) and some starch (we can use any kind of starch like corn starch, rice starch, wheat starch etc.) and we will let them bake slowly. We don't want to bake them with high heat because it is going to cause the water to evaporate very fast. The most important thing in this step, besides baking it slowly, is to keep mixing the product while it is baking so the water can get mixed in evenly. We will keep doing it until the product's color becomes light white (almost a clear color) with no visible water left.

We have to wait and give the product time to cool down a little bit, but not too much. Now we will put the product that we have from step 4 into a press machine (manual or electric) that has holes at the end of it (size of these holes are changeable). While we put the product that we have from step 4 under press, it will come out from other side of the machine like a long string.

While the strings are coming out of the press machine, they will go to cold water to keep their form and quality.

We should keep those strings in cold water for a couple of hours until they completely cool down. During these couple of hours we should keep changing the water or keep adding new cold water so that it doesn't become warm. This will allow the strings to become cooler faster and gets rid of excess that is left over in the warm water. This prevents quality change of strings and also will allow a longer shelf life.

Now, we will slowly mix the product that we got from step 7 and step 4 between 1 to 8 minutes. Due to the fact that the temperature of step 4's product is very low, and because the product that we got from step 7 has water in it, it will help the soft strings to become hard and frozen. While those strings become hard and frozen, they will change their color to dark white. Based on this fact that we are using handspike (manual or automated) to mix these products, it will cause the frozen strings to crush to small pieces and that is what we want.

Now that step 4's product is not as cold as it was, it is sweetened liquid again that we do not need anymore. So we have to take the crushed frozen strings and sweetened liquid apart by using manual of electric filter (strainer) and move all of the crushed strings to the freezer to let them settle for a couple of hours with a layer of step 4 product's just on top of it. This step is important as it will give the final product more durability and a better taste.

After a couple of hours, our plain product is ready for packaging. In this step, we can use any kind of flavors such as, fruit juice (natural, concentrate or artificial), fruit pieces, vegetables or any other kind of flavor that we want to it. The temperature of additive flavors should be under control to prevent any kind of damage to final product's quality and taste.

1- Production line and method for making Frono

2- The method and line for making sweetened liquid according to claim 1, mix water (pasteurized, homogenized or regular) with sweetener. Based on the sweetener, we may need direct or indirect heat to get desired consistency. Then, cool it down so that it does not freeze completely and gets a creamy consistency.

3- The method and line for making clear color baked starch of claim 1, mix water (pasteurized, homogenized or regular) with starch and bake it slowly. Keep mixing product to get all the water absorbed in the mixture until it becomes almost clear. Then, give it time to cool down a little bit.

4- The method and line for slowly mixing products that we got from claim 2 and claim 3 for about 1 to 8 minutes by using mixing method and getting crushed string out of unfrozen sweetened liquid. Then, transfer the crushed string to freezer with layer of product that we got from claim 1 to make the final product more durable and have a long shelf life.

5- Mixing final product that we got from claim 4 with any kind of flavors, chopped fruit, and fruit juice vegetables under controlled temperature.
